(19) United States
(12) Patent Application Publication
(10) Pub. No.: US 2021/0001856 A1
(43) Pub. Date: Jan. 7, 2021

(54) VEHICLE CONTROL DEVICE AND VEHICLE CONTROL METHOD

(71) Applicant: HONDA MOTOR CO., LTD., MINATO-KU, TOKYO (JP)

(72) Inventors: Hiroshi MIURA, WAKO-SHI, SAITAMA-KEN (JP); Suguru YANAGIHARA, WAKO-SHI, SAITAMA-KEN (JP)

(21) Appl. No.: 16/969,444

(22) PCT Filed: Feb. 13, 2018
(86) PCT No.: PCT/JP2018/004768

§ 371 Date: Aug. 12, 2020

(51) Int. Cl. B60W 30/18; G08G 1/095; B60W 30/14; B60W 50/08

(52) U.S. Cl. CPC B60W 30/18154; G08G 1/095; B60W 30/14; B60W 2554/802; B60W 30/18163; B60W 2555/60; B60W 2552/53; B60W 50/087

(57) ABSTRACT

This vehicle control device includes: a traffic light recognition unit which recognizes a traffic light of an own lane along which an own vehicle is traveling; a nearby traffic light setting unit which, in the case where the number of recognized traffic lights recognized by the traffic light recognition unit is plural, sets, one recognized traffic light and another recognized traffic light, when the difference between the distance from the one recognized traffic light to the own vehicle and the distance from the other recognized traffic light to the own vehicle is smaller than a first prescribed distance; a traffic light of interest setting unit which sets, as a traffic light of interest to be noted by the own vehicle, at least one among the plurality of nearby traffic lights; and a travel control unit which performs an acceleration/deceleration control on the own vehicle.

### TECHNICAL FIELD

The present invention relates to a vehicle control device and a vehicle control method for performing travel control of a user's own vehicle at least partially automatically.

### BACKGROUND ART

Japanese Laid-Open Patent Publication No. 2016-218650 discloses a merging determination device that determines, if a predicted trajectory of a user's own vehicle and a travel trajectory of an adjacent vehicle intersect, that the lanes will merge ahead of the user's own vehicle.

### SUMMARY OF INVENTION

One of solutions to reduce the traffic congestion in an expressway is a method called ramp metering. In the ramp metering, a merging traffic light (ramp meter) is placed before an acceleration lane and the number of vehicles to merge with a main lane is restricted. The technique according to Japanese Laid-Open Patent Publication No. 2016-218650, however, does not disclose assistance control at a merging point where the merging traffic light is placed, and it has been a problem that the assistance control cannot be performed at the merging point where the merging traffic light is placed.

The present invention has been made in order to solve the above problem, and an object is to provide a vehicle control device and a vehicle control method capable of performing suitable assistance control at a merging point where a merging signal is placed.

A vehicle control device according to the present invention is a device that performs travel control of a user's own vehicle at least partially automatically, and the vehicle control device includes: a traffic light recognition unit configured to recognize a traffic light that displays a signal for traffic in a user's own vehicle lane where the user's own vehicle is traveling; a close traffic light setting unit configured to, in a case where a plurality of recognition traffic lights that are recognized by the traffic light recognition unit exist and when a difference between a distance from the user's own vehicle to one of the recognition traffic lights and a distance from the user's own vehicle to another of the recognition traffic lights is less than a first predetermined distance or when a distance from the one recognition traffic light to the other recognition traffic light is less than a second predetermined distance, set the one recognition traffic light and the other recognition traffic light as close traffic lights; an attention-needing traffic light setting unit configured to set at least one of a plurality of the close traffic lights as an attention-needing traffic light for the user's own vehicle, on a basis of a positional relation between the user's own vehicle and the close traffic lights; and an assistance control unit configured to perform at least acceleration/deceleration control for the user's own vehicle in accordance with the signal displayed by the attention-needing traffic light. Thus, the vehicle control device can perform suitable assistance control at a merging point where a merging signal is placed.

In the aforementioned vehicle control device, the attention-needing traffic light setting unit may set the positional relation between the user's own vehicle and the close traffic light in accordance with a distance between the user's own vehicle and the close traffic light, a distance between the user's own vehicle and an accompaniment that is placed together with the close traffic light, or a shape of a display unit of the close traffic light. Thus, the vehicle control device can set, as the attention-needing traffic light, one of the two close traffic lights whose display of signal can be recognized by the user's own vehicle more easily.

The aforementioned vehicle control device may further include a plurality of traffic light detection units configured to detect the traffic light in different detection directions with respect to the user's own vehicle, wherein the assistance control unit may select the traffic light detection unit in accordance with a distance between the user's own vehicle and the close traffic light, and perform at least the acceleration/deceleration control for the user's own vehicle in accordance with the signal displayed by the attention-needing traffic light that is detected by the selected traffic light detection unit. Thus, the assistance control unit can perform the acceleration/deceleration control for the user's own vehicle on the basis of information from the traffic light detection unit that detects the signal displayed by the attention-needing traffic light with high accuracy.

The aforementioned vehicle control device may further include an adjacent lane determination unit configured to determine that an adjacent lane that is adjacent to the user's own vehicle lane exists, upon detection of the adjacent lane or detection of an adjacent vehicle that travels adjacent to the user's own vehicle in a same direction, wherein when the adjacent lane exists, the traffic light recognition unit may distinguish between the traffic light that displays the signal for the traffic in the user's own vehicle lane and the traffic light that displays the signal for traffic in the adjacent lane, and recognize, as the recognition traffic light, the traffic light that displays the signal for the traffic in the user's own vehicle lane. Thus, the assistance control unit can perform the acceleration/deceleration control for the user's own vehicle on the basis of the signal displayed by the traffic light that displays the signal for the traffic in the user's own vehicle lane.

In the aforementioned vehicle control device, when a preceding vehicle ahead of the user's own vehicle accelerates, the assistance control unit may restrict acceleration of the user's own vehicle until the user's own vehicle passes a stop line corresponding to the recognition traffic light. If the recognition traffic light is the merging traffic light, the time for which the recognition traffic light displays the signal indicating that forward movement is allowed is shorter than that of the traffic light placed at an intersection or the like. Thus, the vehicle control device enables the user's own vehicle to avoid sudden braking or passing the stop line with respect to the traffic light that displays for the short time the signal indicating that forward movement is allowed.

In the aforementioned vehicle control device, when the user's own vehicle is in a stop state before a stop line corresponding to the recognition traffic light and the traffic light as the recognition traffic light keeps displaying, for a first predetermined time or more, a signal indicating that forward movement is prohibited, the assistance control unit may control the user's own vehicle to repeat traveling and stopping so that the user's own vehicle approaches the stop line corresponding to the recognition traffic light. Thus, in a case where the merging traffic light is a vehicle-actuated traffic light, the assistance control unit makes the user's own vehicle advance gradually so that a sensor of the traffic light can detect the user's own vehicle.

The aforementioned vehicle control device may further include a merging point recognition unit configured to, in a case where a time for which the recognition traffic light displays a signal indicating that forward movement is allowed is less than a second predetermined time, recognize a position of the user's own vehicle as a merging point where a frontage road merges with a main lane, wherein: when the position of the user's own vehicle is the merging point, the close traffic light setting unit may set the close traffic lights as merging traffic lights each displaying a signal to control traffic at the merging point; and the attention-needing traffic light setting unit may set at least one of a plurality of the merging traffic lights as the attention-needing traffic light for the user's own vehicle. Thus, even if the information about the merging point cannot be obtained from the map information or the like, the merging point recognition unit can recognize the merging point on the basis of an external circumstance, and the close traffic light setting unit can set the close traffic lights as the merging traffic lights.

The aforementioned vehicle control device may further include a merging point recognition unit configured to, in a case where an oncoming vehicle does not exist and the user's own vehicle lane is curved, recognize a position of the user's own vehicle as a merging point where a frontage road merges with a main lane, wherein: when the position of the user's own vehicle is the merging point, the close traffic light setting unit may set the close traffic lights as merging traffic lights each displaying a signal to control traffic at the merging point; and the attention-needing traffic light setting unit may set at least one of a plurality of the merging traffic lights as the attention-needing traffic light for the user's own vehicle. Thus, even if the information about the merging point cannot be obtained from the map information or the like, the merging point recognition unit can recognize the merging point on the basis of the external circumstance, and the close traffic light setting unit can set the close traffic lights as the merging traffic lights.

A vehicle control method for performing travel control of a user's own vehicle at least partially automatically includes: a traffic light recognizing step of recognizing a traffic light that displays a signal for traffic in a user's own vehicle lane where the user's own vehicle is traveling; a close traffic light setting step of, in a case where a plurality of recognition traffic lights that are recognized in the traffic light recognizing step exist and when a difference between a distance from the user's own vehicle to one of the recognition traffic lights and a distance from the user's own vehicle to another of the recognition traffic lights is less than a first predetermined distance or when a distance from the one recognition traffic light to the other recognition traffic light is less than a second predetermined distance, setting the one recognition traffic light and the other recognition traffic light as close traffic lights; an attention-needing traffic light setting step of setting at least one of a plurality of the close traffic lights as an attention-needing traffic light for the user's own vehicle on a basis of a positional relation between the user's own vehicle and the close traffic lights; and an assistance control step of performing at least acceleration/deceleration control for the user's own vehicle in accordance with the signal displayed by the attention-needing traffic light. By this vehicle control method, the suitable assistance control can be performed for the user's own vehicle at a merging point where a merging signal is placed.

In the aforementioned vehicle control method, in the attention-needing traffic light setting step, the positional relation between the user's own vehicle and the close traffic light may be set in accordance with a distance between the user's own vehicle and the close traffic light, a distance between the user's own vehicle and an accompaniment that is placed together with the close traffic light, or a shape of a display unit of the close traffic light. By this vehicle control method, one of the two close traffic lights whose display of signal can be recognized by the user's own vehicle more easily can be set as the attention-needing traffic light in the attention-needing traffic light setting step.

In the vehicle control method, the user's own vehicle may include a plurality of traffic light detection units configured to detect the traffic light in different detection directions with respect to the user's own vehicle, and in the assistance control step, the traffic light detection unit may be selected in accordance with a distance between the user's own vehicle and the close traffic light, and at least the acceleration/deceleration control for the user's own vehicle may be performed in accordance with the signal displayed by the attention-needing traffic light that is detected by the selected traffic light detection unit. By this vehicle control method, in the assistance control step, the acceleration/deceleration control for the user's own vehicle can be performed on the basis of the information from the traffic light detection unit that detects the signal displayed by the attention-needing traffic light with high accuracy.

The aforementioned vehicle control method may further include an adjacent lane determining step of determining that an adjacent lane that is adjacent to the user's own vehicle lane exists, upon detection of the adjacent lane or detection of an adjacent vehicle that travels adjacent to the user's own vehicle in a same direction, wherein in the traffic light recognizing step, when the adjacent lane exists, the traffic light that displays the signal for the traffic in the user's own vehicle lane and the traffic light that displays the signal for traffic in the adjacent lane may be distinguished, and the traffic light that displays the signal for the traffic in the user's own vehicle lane may be recognized as the recognition traffic light. By this vehicle control method, in the assistance control step, the acceleration/deceleration control for the user's own vehicle can be performed on the basis of the signal displayed by the traffic light that displays the signal for the traffic in the user's own vehicle lane.

In the aforementioned vehicle control method, in the assistance control step, when a preceding vehicle ahead of the user's own vehicle accelerates, acceleration of the user's own vehicle may be restricted until the user's own vehicle passes a stop line corresponding to the recognition traffic light. By this vehicle control method, in the assistance control step, the user's own vehicle can avoid sudden braking or passing the stop line with respect to the traffic light that displays for the short time the signal indicating that forward movement is allowed.

In the aforementioned vehicle control method, in the assistance control step, when the user's own vehicle is in a stop state before a stop line corresponding to the recognition traffic light and the traffic light as the recognition traffic light keeps displaying, for a first predetermined time or more, a signal indicating that forward movement is prohibited, the user's own vehicle may be caused to repeat traveling and stopping so that the user's own vehicle approaches the stop line corresponding to the recognition traffic light. By this vehicle control method, in the assistance control step, in the case where the merging traffic light is a vehicle-actuated traffic light, the user's own vehicle advances gradually so that the sensor of the traffic light can detect the user's own vehicle.

The aforementioned vehicle control method may further include a merging point recognizing step of, in a case where a time for which the recognition traffic light displays a signal indicating that forward movement is allowed is less than a second predetermined time, recognizing a position of the user's own vehicle as a merging point where a frontage road merges with a main lane, wherein: in the close traffic light setting step, when the position of the user's own vehicle is the merging point, the close traffic lights may be set as merging traffic lights each displaying a signal to control traffic at the merging point; and in the attention-needing traffic light setting step, at least one of a plurality of the merging traffic lights may be set as the attention-needing traffic light for the user's own vehicle. By this vehicle control method, even if the information about the merging point cannot be obtained from the map information or the like, the merging point can be recognized on the basis of the external circumstance in the merging point recognizing step, and the close traffic lights can be set as the merging traffic lights in the close traffic light setting step.

The aforementioned vehicle control method may further include a merging point recognizing step of, in a case where an oncoming vehicle does not exist and the user's own vehicle lane is curved, recognizing a position of the user's own vehicle as a merging point where a frontage road merges with a main lane, wherein: in the close traffic light setting step, when the position of the user's own vehicle is the merging point, the close traffic lights may be set as merging traffic lights each displaying a signal to control traffic at the merging point; and in the attention-needing traffic light setting step, at least one of a plurality of the merging traffic lights may be set as the attention-needing traffic light for the user's own vehicle. By this vehicle control method, even if the information about the merging point cannot be obtained from the map information or the like, the merging point can be recognized on the basis of the external circumstance in the merging point recognizing step, and the close traffic lights can be set as the merging traffic lights in the close traffic light setting step.

By the vehicle control device and the vehicle control method according to the present invention, the suitable assistance control can be performed at the merging point where the merging signal is placed.

### BRIEF DESCRIPTION OF DRAWINGS

FIG. 1 is a diagram for describing ramp metering;

FIG. 2 is a schematic diagram illustrating an example of a merging traffic light;

FIG. 3 is a block diagram illustrating a structure of a vehicle control device;

FIG. 4 is a function block diagram of a processing unit;

FIG. 5 is a flowchart showing a procedure of a process of merging assistance control performed in the vehicle control device;

FIG. 6 is a flowchart showing the procedure of the process of the merging assistance control performed in the vehicle control device;

FIG. 7 is a flowchart showing the procedure of the process of the merging assistance control performed in step S13;

FIG. 8 is a flowchart showing the procedure of the process of the merging assistance control performed in step S16; and

FIG. 9 is a flowchart showing the procedure of the process of the merging assistance control performed in step S16.

### DESCRIPTION OF EMBODIMENT

### First Embodiment

### [About Ramp Metering]

One of the solutions to reduce the traffic congestion in expressways is a method called ramp metering. In the ramp metering, a merging traffic light (ramp meter) 108 is placed before an acceleration lane 106, which is a merging point where a frontage road 102 merges with a main lane 104 in an expressway 100. With this ramp metering, the number of vehicles to merge with the main lane 104 from the frontage road 102 is restricted.

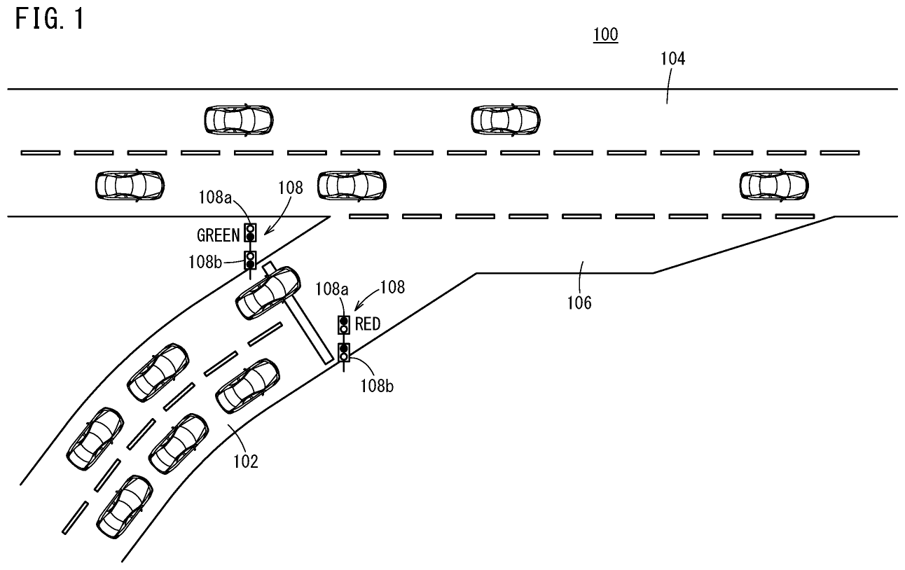

A vehicle control device 10 according to the present embodiment is a device that performs merging assistance for a driver of a user's own vehicle at the merging point on the expressway 100 where the merging traffic light 108 is placed. FIG. 1 is a diagram for describing the ramp metering. The merging traffic light 108 is provided for each lane in the frontage road 102. The merging traffic light 108, which displays a red signal and a green signal alternately, displays the red signal most of the time and displays the green signal just for several seconds. When the merging traffic light 108 displays the green signal, only one vehicle in the frontage road 102 is allowed to enter the acceleration lane 106. Note that the time for which the merging traffic light 108 displays the green signal is shorter than the time for which the traffic light placed at the intersection or the like displays the green signal. In addition, the period in which the merging traffic light 108 displays the red signal and the green signal is often shorter than the time for which the traffic light placed at the intersection or the like displays the red signal and the green signal.

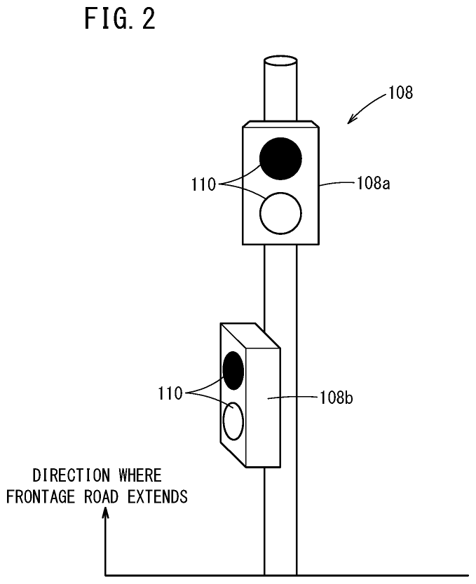

FIG. 2 is a schematic diagram illustrating one example of the merging traffic light 108. The merging traffic light 108 is usually formed by two traffic lights that are arranged vertically. A far traffic light 108a that is disposed on the upper side displays a signal for the driver of the vehicle that exists far from the merging traffic light 108. A display unit 110 that displays the signal of the far traffic light 108a is provided to face the substantial front of the vehicle that travels in the frontage road 102. In other words, the display unit 110 that displays the signal of the far traffic light 108a is provided so that the orientation of the display unit 110 is approximately parallel to a direction where the frontage road 102 extends. A near traffic light 108b that is disposed on the lower side displays a signal for the driver of the vehicle that exists near the merging traffic light 108. The display unit 110 that displays the signal of the near traffic light 108b is provided to be directed obliquely to the front of the vehicle that travels in the frontage road 102. In other words, the display unit 110 that displays the signal of the near traffic light 108b is provided so that the orientation of the display unit 110 is oblique to the direction where the frontage road 102 extends.

The display of the far traffic light 108a and the display of the near traffic light 108b in the merging traffic light 108 are the same. That is to say, when the far traffic light 108a displays the red signal, the near traffic light 108b also displays the red signal, and when the far traffic light 108a displays the green signal, the near traffic light 108b also displays the green signal. In the merging traffic light 108, the far traffic light 108a and the near traffic light 108b are provided to the same pole, for example, and these traffic lights are provided close to each other.

### [Structure of Vehicle Control Device]

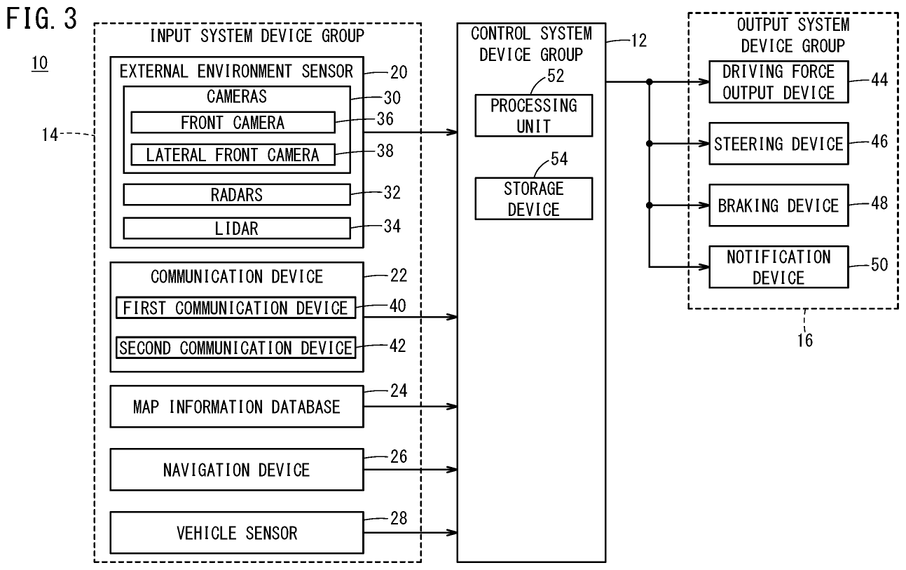

FIG. 3 is a block diagram illustrating a structure of the vehicle control device 10. The vehicle control device 10 is incorporated in the vehicle, and performs driving control of the vehicle automatically or manually. The term “automated driving” in the present embodiment refers to a concept including not only “fully automated driving” in which travel control of the vehicle is fully automated but also “partial automated driving” in which the travel control is partially automated.

The vehicle control device 10 includes a control system device group 12 that collectively controls the driving of the vehicle, an input system device group 14 that performs an input function of the control system device group 12, and an output system device group 16 that performs an output function of the control system device group 12.

### <Structure of Input System Device Group>

The input system device group 14 includes: an external environment sensor 20 that detects a state of a periphery (external environment) of the vehicle; a communication device 22 that exchanges information with various communication devices outside the vehicle; a map information database 24 that acquires map information expressing a high-precision map; a navigation device 26 that generates a travel route to a destination and measures a travel position of the vehicle; and a vehicle sensor 28 that detects a state of the vehicle.

The external environment sensor 20 includes one or more cameras 30 that capture images of the external environment, one or more radars 32 that detect the distance and the relative speed between the user's own vehicle and another object, and one or more LIDARs 34 (Light Detection and Ranging/Laser Imaging Detection and Ranging).

The cameras 30 include at least a front camera 36 that captures an image of an area ahead of the user's own vehicle, and a lateral front camera 38 that captures an image of an area laterally ahead of the user's own vehicle. The cameras 30 capture images of the traffic light ahead of or laterally ahead of the user's own vehicle, for example. The images of the traffic light captured by the cameras 30 are analyzed, so that the distance between the user's own vehicle and the traffic light, the distance between the two traffic lights, the signal of the traffic light (red signal, green signal, yellow signal, or figure signal), the time for which the traffic light shows each signal, and the like can be obtained.

The communication device 22 includes a first communication device 40 that performs inter-vehicle communication between the user's own vehicle and another vehicle, and a second communication device 42 that performs road-vehicle communication between the user's own vehicle and a road-side device. Note that if the other vehicle or the road-side device owns the information about the distance between the user's own vehicle and the traffic light, the distance between the two traffic lights, the signal of the traffic light (red signal, green signal, yellow signal, or figure signal), the time for which the traffic light shows each signal, and the like that are described above, these pieces of information may be acquired by the first communication device 40 or the second communication device 42.

The navigation device 26 includes a satellite navigation system and a self-contained navigation system. The vehicle sensor 28 includes various sensors that detect behavior of the vehicle, such as a vehicle speed sensor, an acceleration sensor, a yaw rate sensor, and an inclination sensor, various sensors that detect an operation state of the vehicle, and various sensors that detect the state of the driver.

### <Structure of Output System Device Group>

The output system device group 16 includes a driving force output device 44, a steering device 46, a braking device 48, and a notification device 50.

The driving force output device 44 includes a driving force output ECU (Electronic Control Unit), and a driving source such as an engine or a traction motor. The driving force output device 44 generates driving force in response to operation of the driver on an accelerator pedal or a driving control instruction that is output from the control system device group 12.

The steering device 46 includes an EPS (Electric Power Steering System)-ECU, and an EPS actuator. The steering device 46 generates steering force in response to operation of the driver on a steering wheel or a steering control instruction that is output from the control system device group 12.

The braking device 48 includes a brake ECU and a brake actuator. The braking device 48 generates braking force in response to operation of the driver on a brake pedal or a braking control instruction that is output from the control system device group 12.

The notification device 50 includes a notification ECU and an information transmission device (such as a display device, an audio device, or a haptic device). The notification device 50 notifies the driver in response to a notification instruction that is output from the control system device group 12 or another ECU (for example, provides information through any of five senses including visual and auditory senses).

### <Structure of Control System Device Group>

The control system device group 12 includes one or more ECUs, and includes a processing unit 52 such as a processor, and a storage device 54 such as a ROM or a RAM. The control system device group 12 achieves various functions when the processing unit 52 executes programs stored in the storage device 54.

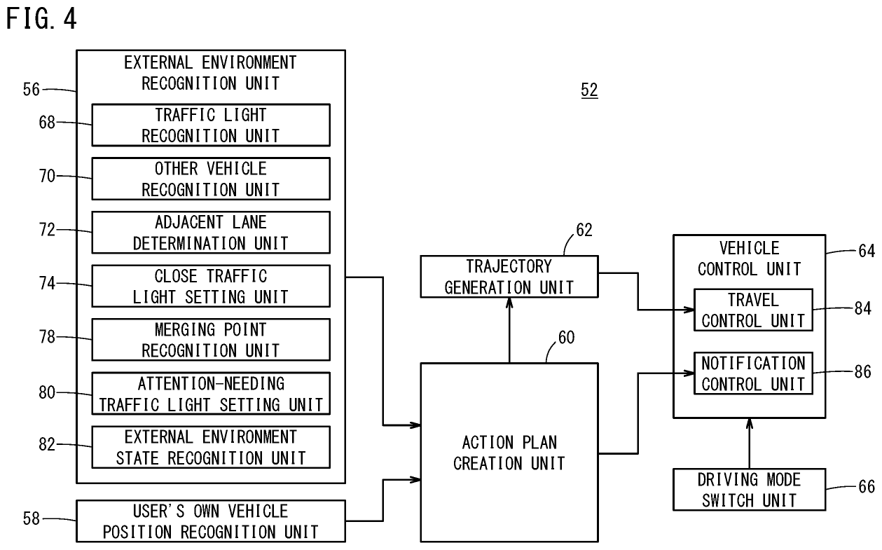

FIG. 4 is a function block diagram of the processing unit 52. This processing unit 52 is configured to be able to perform various functions of an external environment recognition unit 56, a user's own vehicle position recognition unit 58, an action plan creation unit 60, a trajectory generation unit 62, a vehicle control unit 64, and a driving mode switch unit 66.

The external environment recognition unit 56 recognizes a circumstance and an object around the vehicle on the basis of information output from the external environment sensor 20. This external environment recognition unit 56 includes a traffic light recognition unit 68, an other vehicle recognition unit 70, an adjacent lane determination unit 72, a close traffic light setting unit 74, a merging point recognition unit 78, an attention-needing traffic light setting unit 80, and an external environment state recognition unit 82.

The traffic light recognition unit 68 recognizes that a traffic light exists ahead of the user's own vehicle on the basis of image information from the cameras 30. The traffic light recognition unit 68 distinguishably recognizes the traffic light that displays the signal for the traffic in the user's own vehicle lane and the traffic light that displays the signal for the traffic in the adjacent lane, and sets the traffic light that displays the signal for the traffic in the user's own vehicle lane as a recognition traffic light.

The other vehicle recognition unit 70 recognizes the presence or absence, the position, the size, and the type of the other vehicle that travels or stops near the user's own vehicle on the basis of the information output from the cameras 30, the radars 32, or the LIDARs 34, for example, and calculates the distance and the relative speed between the user's own vehicle and the other vehicle.

The adjacent lane determination unit 72 determines that the adjacent lane exists when the other vehicle recognition unit 70 has recognized the adjacent vehicle that is adjacent to the user's own vehicle and travels in the same direction as the user's own vehicle. In addition, the adjacent lane determination unit 72 may directly determine whether the adjacent lane exists on the basis of the information output from the cameras 30, the radars 32, or the LIDARs 34.

For example, in a case where the traffic light recognition unit 68 has recognized a plurality of recognition traffic lights and the distance between two of the plurality of recognition traffic lights is less than a predetermined distance L1 on the basis of the information output from the cameras 30, the radars 32, or the LIDARs 34, for example, the close traffic light setting unit 74 sets these two recognition traffic lights as the close traffic lights. In addition, in a case where the traffic light recognition unit 68 has recognized a plurality of recognition traffic lights and a difference between the distances between the user's own vehicle and the two recognition traffic lights is less than a predetermined distance L2, the close traffic light setting unit 74 may set these two recognition traffic lights as the close traffic lights.

In this manner, in a case where two traffic lights are placed closely like the merging traffic light 108, these two traffic lights are set as the close traffic lights. On the other hand, in a case where two traffic lights are placed in the user's own vehicle lane at a certain distance from each other such as a traffic light placed at the intersection near the user's own vehicle and a traffic light placed at the intersection far from the user's own vehicle, these two traffic lights are not set as the close traffic lights.

The merging point recognition unit 78 recognizes that the merging point where the frontage road 102 merges with the main lane 104 in the expressway 100 exists ahead of the user's own vehicle on the basis of the map information read out from the map information database 24 and travel position information of the user's own vehicle input from the navigation device 26, for example. Moreover, if the image information from the cameras 30 indicates there is no oncoming vehicle ahead of the user's own vehicle and the user's own vehicle lane ahead of the user's own vehicle is curved, the merging point recognition unit 78 may recognize the merging point exists ahead of the user's own vehicle. In addition, if the image information from the cameras 30 indicates the time for which the close traffic light displays the green signal is less than a predetermined time T1, the merging point recognition unit 78 may recognize the merging point exists ahead of the user's own vehicle. Furthermore, if the image information from the cameras 30 indicates the period in which the close traffic light displays the red signal and the green signal is less than a predetermined time T2, the merging point recognition unit 78 may recognize the merging point exists ahead of the user's own vehicle.

When the distance between the user's own vehicle and the two close traffic lights is more than or equal to a predetermined distance L3 on the basis of the information output from the cameras 30, the radars 32, or the LIDARs 34, for example, the attention-needing traffic light setting unit 80 sets the upper traffic light of the two close traffic lights as the attention-needing traffic light. When the distance between the user's own vehicle and the two close traffic lights is less than the predetermined distance L3, the attention-needing traffic light setting unit 80 sets the lower traffic light of the two close traffic lights as the attention-needing traffic light.

The attention-needing traffic light setting unit 80 may set the attention-needing traffic light in accordance with the distance to an accompaniment to the close traffic light for the user's own vehicle (for example, a pole that supports the close traffic light or a stop line on a road).

In addition, the attention-needing traffic light setting unit 80 may set the attention-needing traffic light in accordance with the shape of the display unit of the close traffic light. In a case where the close traffic light is the merging traffic light 108 as illustrated in FIG. 2, the shape of the display unit 110 of the near traffic light 108b changes from the elliptical shape to the perfectly circular shape as the user's own vehicle approaches the merging traffic light 108. In addition, in a case where the display unit 110 of the near traffic light 108b displays a figure such as an arrow, the shape of the display on the display unit 110 of the near traffic light 108b changes as the user's own vehicle approaches the merging traffic light 108.

Regarding the shape of the display unit 110 of the near traffic light 108b and the shape of the figure displayed on the display unit 110 of the near traffic light 108b, the attention-needing traffic light setting unit 80 may store a predetermined shape, which enables the easy recognition of the display on the display unit 110, in advance and perform pattern matching with the image information from the cameras 30. Thus, when the predetermined shape is obtained, the attention-needing traffic light setting unit 80 may switch the far traffic light 108a to the near traffic light 108b as the attention-needing traffic light.

For example, the external environment state recognition unit 82 recognizes an overall road environment including the shape and the width of the road, the position of the lane mark, the number of the lanes and the width of the lanes, the lighting state of the traffic light, the open/close state of a crossing gate, and the like, on the basis of the image information from the cameras 30 or the map information read out from the map information database 24.

The user's own vehicle position recognition unit 58 recognizes an absolute position of the vehicle or a relative position thereof on the high-precision map (hereinafter also referred to as user's own vehicle position) on the basis of the information output from the navigation device 26 and the map information database 24.

The action plan creation unit 60 creates an action plan (events in time series for each travel section) in accordance with the status of the vehicle on the basis of recognition results from the external environment recognition unit 56 and the user's own vehicle position recognition unit 58, and updates contents of the action plan as necessary.

The trajectory generation unit 62 generates a travel trajectory (target behavior in time series) in accordance with the action plan created by the action plan creation unit 60, on the basis of the recognition results from the external environment recognition unit 56 and the user's own vehicle position recognition unit 58.

On the basis of a creation result from the action plan creation unit 60 or a generation result from the trajectory generation unit 62, the vehicle control unit 64 instructs the output system device group 16 (FIG. 3) to operate. The vehicle control unit 64 includes a travel control unit 84 that performs the travel control of the user's own vehicle, for example steering control or acceleration/deceleration control, and a notification control unit 86 that performs notification control for the driver.

The driving mode switch unit 66 is configured to be able to switch a plurality of driving modes including “automated driving mode” and “manual driving mode” in response to a predetermined action of the driver (for example, the operation of an input device including a switch and the steering wheel). A request action from the driver to make a transition from the automated driving to the manual driving is also referred to as “takeover request (TOR: Take Over Request)”.

### [Merging Assistance Control Process]

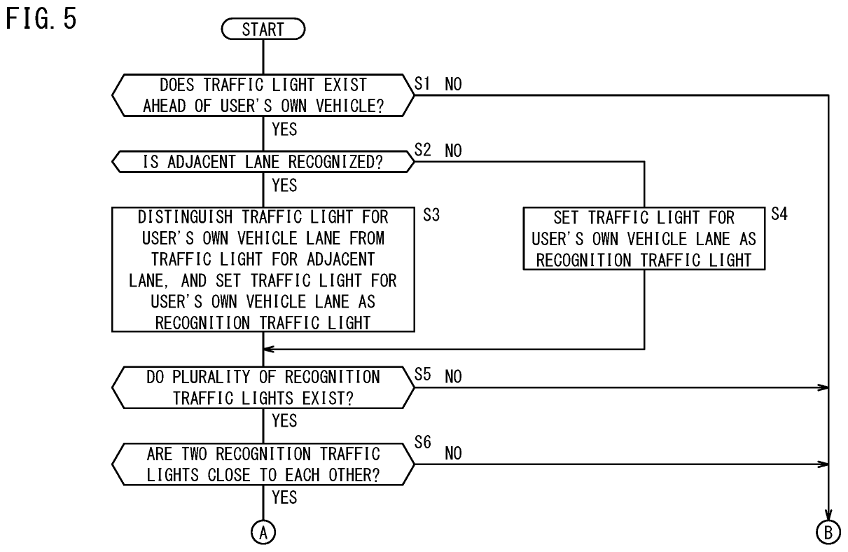

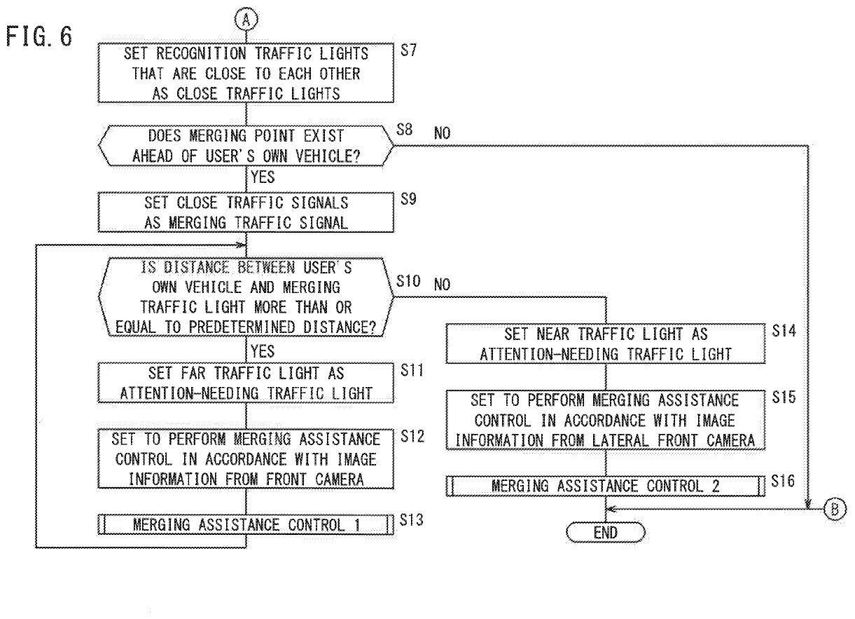

A process of merging assistance control at the merging point where the merging traffic light 108 is placed is described. This process is performed in the vehicle control device 10 according to the present embodiment. The merging assistance refers to the driving assistance for the driver of the user's own vehicle performed when the user's own vehicle merges with the main lane 104 from the frontage road 102 in the expressway 100 (FIG. 1). FIG. 5 and FIG. 6 are flowcharts showing the procedure of the process in the merging assistance control that is performed in the vehicle control device 10.

In step S1, the traffic light recognition unit 68 determines whether the traffic light exists ahead of the user's own vehicle. If the traffic light exists ahead of the user's own vehicle, the process advances to step S2, and if the traffic light does not exist ahead of the user's own vehicle, the process ends. Note that in a case where the user's own vehicle travels on a curved road, the traffic light recognition unit 68 may determine whether the traffic light exists on the lateral front side of the user's own vehicle. Regarding determination as to whether the traffic light exists, the direction of the traffic light with respect to the user's own vehicle may be set depending on the curvature of the curved road.

In step S2, the adjacent lane determination unit 72 determines whether the adjacent lane is recognized. If the adjacent lane determination unit 72 recognizes the adjacent lane, the process advances to step S3, and if the adjacent lane determination unit 72 does not recognize the adjacent lane, the process advances to step S4.

In step S3, the traffic light recognition unit 68 distinguishes the traffic light ahead of the user's own vehicle from the traffic light for the adjacent lane and sets the traffic light for the user's own vehicle lane as the recognition traffic light, and then, the process advances to step S5. In step S4, the traffic light recognition unit 68 sets the traffic light ahead of the user's own vehicle as the recognition traffic light, and the process advances to step S5.

In step S5, the traffic light recognition unit 68 determines whether a plurality of recognition traffic lights exist. If a plurality of recognition traffic lights exist, the process advances to step S6, and if there is only one recognition traffic light, the process ends.

In step S6, the close traffic light setting unit 74 determines whether two of the recognition traffic lights among the recognition traffic lights recognized by the traffic light recognition unit 68 are close to each other. The two recognition traffic lights are determined to be close to each other when the distance between the two recognition traffic lights is less than the predetermined distance L1 or when the difference between the distances between the user's own vehicle and the two recognition traffic lights is less than the predetermined distance L2 as described above. If the two recognition traffic lights are close to each other, the process advances to step S7, and if the two recognition traffic lights are not close to each other, the process ends. In step S7, the close traffic light setting unit 74 sets, as the close traffic lights, the certification traffic lights that have been determined to be close to each other, and then the process advances to step S8.

In step S8, the merging point recognition unit 78 determines whether the merging point exists ahead of the user's own vehicle. If the merging point exists ahead of the user's own vehicle, the process advances to step S9, and if the merging point does not exist ahead of the user's own vehicle, the process ends.

In step S9, the close traffic light setting unit 74 sets the close traffic lights as the merging traffic light 108 and the process advances to step S10. In step S10, the attention-needing traffic light setting unit 80 determines whether the distance between the user's own vehicle and the close traffic light is more than or equal to the predetermined distance L3. If the distance between the user's own vehicle and the close traffic light is more than or equal to the predetermined distance L3, the process advances to step S11, and if the distance between the user's own vehicle and the close traffic light is less than the predetermined distance L3, the process advances to step S14.

In step S11, the attention-needing traffic light setting unit 80 sets the upper traffic light (far traffic light 108a) of the close traffic lights as the attention-needing traffic light and then, the process advances to step S12. In step S12, the action plan creation unit 60 sets so that the merging assistance control is performed in accordance with the display of the attention-needing traffic light obtained from the image information from the front camera 36a, and the process advances to step S13. In step S13, the action plan creation unit 60 creates an action plan so that the travel control unit 84 performs the merging assistance control for the user's own vehicle, and the process returns to step S10. The merging assistance control that is performed here is described in detail below.

In step S14, which is performed after the distance between the user's own vehicle and the close traffic light is determined to be less than the predetermined distance L3 in step S10, the attention-needing traffic light setting unit 80 sets the lower traffic light (near traffic light 108b) of the close traffic lights as the attention-needing traffic light and then, the process advances to step S15. In step S15, the action plan creation unit 60 sets so that the merging assistance control is performed in accordance with the display of the attention-needing traffic light obtained from the image information from the lateral front camera 38b, and the process advances to step S16. In step S16, the action plan creation unit 60 creates an action plan so that the travel control unit 84 performs the merging assistance control for the user's own vehicle, and the process ends. The merging assistance control that is performed here is described in detail below.

In the flowcharts in FIG. 5 and FIG. 6, the close traffic light setting unit 74 sets the close traffic light in steps S5 to S7, and then in step S8, the merging point recognition unit 78 determines whether the merging point exists ahead of the user's own vehicle. Alternatively, the close traffic light setting unit 74 may set the close traffic light in a case where the merging point recognition unit 78 determines whether the merging point exists ahead of the user's own vehicle and as a result, it is determined that the merging point exists. If the merging point recognition unit 78 determines that the merging point exists ahead of the user's own vehicle, it is highly likely that the traffic light ahead of the user's own vehicle is the merging traffic light 108. If the close traffic light setting unit 74 sets the close traffic light only when the merging point recognition unit 78 has determined that the merging point exists ahead of the user's own vehicle, the process burden in the processing unit 52 can be reduced.

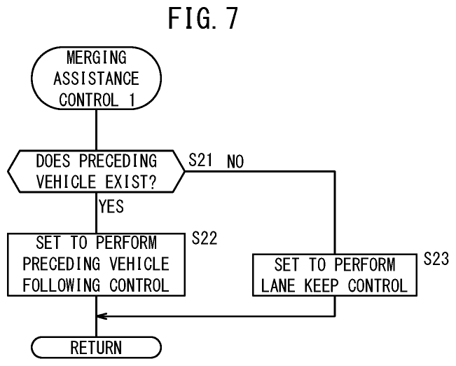

FIG. 7 is a flowchart showing the procedure in the process of the merging assistance control in step S13. In step S21, the action plan creation unit 60 determines whether a preceding vehicle exists ahead of the user's own vehicle on the basis of information from the external environment state recognition unit 82. If the preceding vehicle exists ahead of the user's own vehicle, the process advances to step S22, and if the preceding vehicle does not exist ahead of the user's own vehicle, the process advances to step S23.

In step S22, the action plan creation unit 60 creates an action plan so that preceding vehicle following control is performed for the user's own vehicle, and the process ends. In the preceding vehicle following control, the travel control unit 84 controls the user's own vehicle so that the user's own vehicle travels following the preceding vehicle with the inter-vehicle distance between the user's own vehicle and the preceding vehicle kept suitable for the vehicle speed. Here, in a case where the preceding vehicle accelerates, the user's own vehicle is controlled so that the acceleration thereof is restricted to be less than predetermined acceleration. In this case, it is considered that the merging traffic light 108 ahead of the preceding vehicle turns green and the preceding vehicle has started. The time for which the merging traffic light 108 displays the green signal is shorter than the time for which the traffic light placed at the intersection or the like displays the green signal, and the merging traffic light 108 displaying the green signal turns red quickly. Thus, by suppressing the acceleration of the user's own vehicle, the user's own vehicle can avoid sudden braking or passing the stop line.

In step S23, the action plan creation unit 60 creates an action plan so that lane keep control is performed for the user's own vehicle, and the process ends. In the lane keep control, the travel control unit 84 controls the user's own vehicle so that the user's own vehicle keeps traveling in the user's own vehicle lane. Note that in the lane keep control, the user's own vehicle can be controlled so as to keep traveling in the user's own vehicle lane and moreover, the user's own vehicle can be controlled so as to travel departing from the user's own vehicle lane temporarily in consideration of the position of the preceding vehicle in the width direction of the user's own vehicle lane and the position of an obstacle (for example, guard rail) beside the user's own vehicle lane, for example.

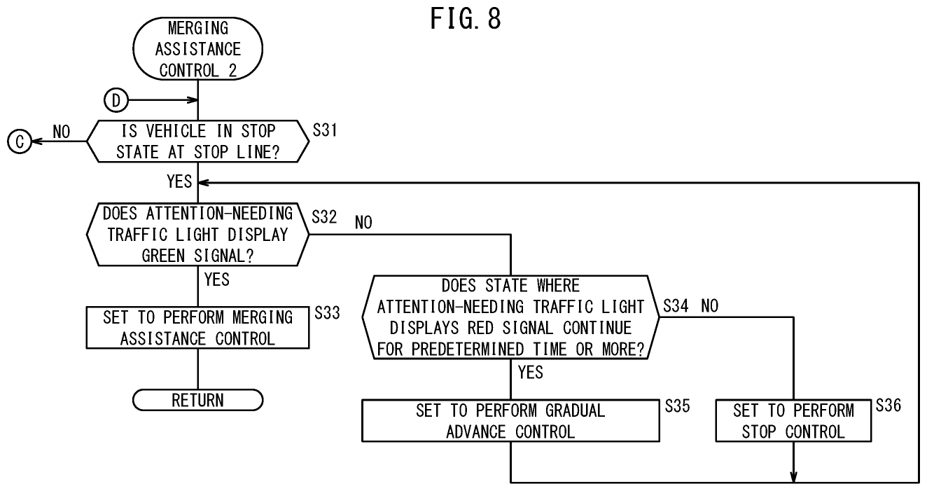

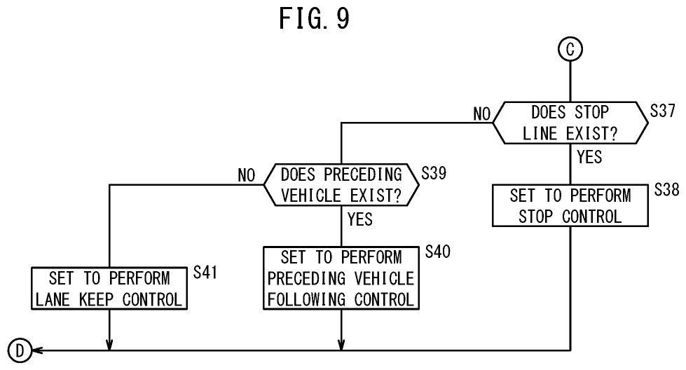

FIG. 8 and FIG. 9 are flowcharts showing the procedure in the process of the merging assistance control in step S16. In step S31, the action plan creation unit 60 determines whether the user's own vehicle is in a stop state at the stop line on the basis of the information from the external environment state recognition unit 82. If the user's own vehicle is in the stop state at the stop line, the process advances to step S32, and if the user's own vehicle is not in the stop state at the stop line, the process advances to step S37.

In step S32, the action plan creation unit 60 determines whether the attention-needing traffic light displays the green signal on the basis of the information from the external environment state recognition unit 82. If the attention-needing traffic light displays the green signal, the process advances to step S33, and if the attention-needing traffic light displays the red signal, the process advances to step S34.

In step S33, the action plan creation unit 60 creates an action plan so that the merging assistance control is performed for the user's own vehicle, and the process ends. In the merging assistance control, the travel control unit 84 controls the user's own vehicle so that the user's own vehicle accelerates sufficiently in the acceleration lane 106 (FIG. 1) and then merges with the lane that is adjacent to the acceleration lane 106 in the main lane 104 (FIG. 1). Note that instead of starting the user's own vehicle automatically when the display of the attention-needing traffic light changes from the red signal to the green signal, the travel control unit 84 may start the user's own vehicle when the driver operates a GO/STOP button (not shown) that is provided inside the user's own vehicle. Regarding the function of the GO/STOP button, the user's own vehicle may be started when the GO/STOP button is pushed by the driver or when the GO/STOP button pushed by the driver is released. Thus, the driver can decide whether to start the user's own vehicle and can feel safe when starting the user's own vehicle.

In step S34, the action plan creation unit 60 determines whether the state where the attention-needing traffic light displays the red signal continues for a predetermined time T3 or more on the basis of the information from the external environment state recognition unit 82. If the state where the attention-needing traffic light displays the red signal continues for the predetermined time T3 or more, the process advances to step S35, and if the state where the attention-needing traffic light displays the red signal continues for less than the predetermined time T3, the process advances to step S36.

In step S35, the action plan creation unit 60 creates an action plan so that gradual advance control is performed for the user's own vehicle, and then the process returns to step S32. In the gradual advance control, the travel control unit 84 controls the user's own vehicle so that the user's own vehicle travels a little and then stops. This gradual advance control is repeated until the display of the attention-needing traffic light turns green.

When the user's own vehicle is close to the stop line, the cameras 30 may fail to capture an image of the stop line. In this case, the external environment state recognition unit 82 cannot recognize the position of the stop line from the image information from the cameras 30. Therefore, the external environment state recognition unit 82 estimates the position of the stop line from the image information captured by the cameras 30 when the user's own vehicle is away from the stop line. However, the estimated position of the stop line contains many errors; therefore, it is difficult to stop the user's own vehicle right before the stop line. Accordingly, for example, in a case where the merging traffic light 108 is a vehicle-actuated traffic light that turns green when the vehicle exists at the stop line, the user's own vehicle may stop away from the stop line to such a degree that the user's own vehicle cannot be detected by the sensor of the traffic light. In such a case, as described above, by performing the gradual advance control for the user's own vehicle, the sensor of the traffic light can detect the user's own vehicle.

In step S36, the action plan creation unit 60 creates an action plan so that stop control is performed for the user's own vehicle, and then the process returns to step S32. In the stop control, the travel control unit 84 controls the user's own vehicle so that the user's own vehicle keeps stopping.

In step S37 after it is determined that the user's own vehicle is not in the stop state at the stop line in step S31, the action plan creation unit 60 determines whether the stop line exists ahead of the user's own vehicle on the basis of the information from the external environment state recognition unit 82. If the stop line exists ahead of the user's own vehicle, the process advances to step S38, and if the stop line does not exist ahead of the user's own vehicle, the process advances to step S39.

In step S38, the action plan creation unit 60 creates an action plan so that the stop control is performed for the user's own vehicle, and then the process returns to step S31. In the stop control, the travel control unit 84 controls the user's own vehicle so that the user's own vehicle stops right before the stop line.

In step S39, the action plan creation unit 60 determines whether the preceding vehicle exists ahead of the user's own vehicle on the basis of the information from the external environment state recognition unit 82. In a case where the preceding vehicle exists ahead of the user's own vehicle, the process advances to step S40, and if the preceding vehicle does not exist ahead of the user's own vehicle, the process advances to step S41.

In step S40, the action plan creation unit 60 creates an action plan so that the preceding vehicle following control is performed for the user's own vehicle, and then the process returns to step S31. In the preceding vehicle following control, the travel control unit 84 controls the user's own vehicle so that the user's own vehicle travels following the preceding vehicle with the inter-vehicle distance between the user's own vehicle and the preceding vehicle kept suitable for the vehicle speed. Here, in a case where the preceding vehicle accelerates right before the merging traffic light 108, the user's own vehicle is controlled so that the acceleration is suppressed to be less than the predetermined acceleration.

In step S41, the action plan creation unit 60 creates an action plan so that the lane keep control is performed for the user's own vehicle, and then the process returns to step S31. In the lane keep control, the travel control unit 84 controls the user's own vehicle so that the user's own vehicle keeps traveling in the user's own vehicle lane.

In the merging assistance control described above, in a case where the traffic volume in the adjacent lane is smaller than that in the user's own vehicle lane, the travel control unit 84 may control the user's own vehicle so that the user's own vehicle moves to the adjacent lane.

In the aforementioned example, the green signal indicates that the vehicle can advance, and the red signal indicates that the vehicle must stop. The signal is not limited to the green or red signal and may be replaced by a figure or a letter, for example.

### [Operation Effects]

The conventional vehicle control device that performs the merging assistance control did not envisage the merging assistance control at the merging point where the merging traffic light 108 is placed. In addition, the merging traffic light 108 includes the far traffic light 108a and the near traffic light 108b (FIG. 2) and it has been necessary to switch the traffic light to be paid attention to, between the far traffic light 108a and the near traffic light 108b depending on the distance between the user's own vehicle and the merging traffic light 108.

In view of this, in the present embodiment, in the case where there are a plurality of recognition traffic lights set as the traffic lights that display the signal for the traffic in the user's own vehicle lane and two of the plurality of recognition traffic lights are close to each other, the close traffic light setting unit 74 sets these two traffic lights as the close traffic lights. Thus, the traffic lights including the far traffic light 108a and the near traffic light 108b like the merging traffic light 108 can be set as the close traffic lights, and these traffic lights can be distinguished from the traffic lights that are placed at the intersection or the like.

Moreover, in the present embodiment, the travel control unit 84 selects one of the front camera 36 and the lateral front camera 38 in accordance with the distance between the user's own vehicle and the merging traffic light 108, and on the basis of the signal displayed by the merging traffic light 108 detected by the selected camera 30, the travel control unit 84 performs the merging assistance control for the user's own vehicle. Thus, the travel control unit 84 can perform the merging assistance control for the user's own vehicle on the basis of the image information from the camera 30 that can detect the signal displayed by the merging traffic light 108 with high accuracy.

In addition, in the present embodiment, when the adjacent lane exists, the traffic light recognition unit 68 distinguishes between the traffic light that displays the signal for the traffic in the user's own vehicle lane and the traffic light that displays the signal for the traffic in the adjacent lane, and recognizes, as the recognition traffic light, the traffic light that displays the signal for the traffic in the user's own vehicle lane. Thus, the travel control unit 84 can perform the merging assistance control for the user's own vehicle on the basis of the signal displayed by the traffic light that displays the signal for the traffic in the user's own vehicle lane.

In the present embodiment, in the case where the time for which the adjacent traffic light displays the green signal is less than the predetermined time T1, the merging point recognition unit 78 recognizes that the merging point exists ahead of the user's own vehicle. In the case where the oncoming vehicle does not exist ahead of the user's own vehicle and the user's own vehicle lane ahead of the user's own vehicle is curved, the merging point recognition unit 78 recognizes that the merging point exists ahead of the user's own vehicle. Then, if the merging point exists ahead of the user's own vehicle, the close traffic light setting unit 74 sets the close traffic lights as the merging traffic light 108. Thus, even if the information about the merging point cannot be obtained from the map information or the like, the merging point recognition unit 78 can recognize the merging point on the basis of the external circumstance.

In the present embodiment, the attention-needing traffic light setting unit 80 sets at least one of the close traffic lights as the attention-needing traffic light for the user's own vehicle on the basis of the positional relation between the user's own vehicle and the close traffic lights. The travel control unit 84 performs the merging assistance control for the user's own vehicle in accordance with the signal displayed by the attention-needing traffic light that has been set. Thus, the vehicle control device 10 according to the present embodiment sets the attention-needing traffic light on the basis of the positional relation between the user's own vehicle and the merging traffic lights 108; therefore, the suitable merging assistance control can be performed at the merging point where the merging traffic light 108 is placed.

In the present embodiment, the attention-needing traffic light setting unit 80 sets the positional relation between the user's own vehicle and the close traffic light in accordance with the distance between the user's own vehicle and the merging traffic light 108, the distance between the user's own vehicle and the accompaniment that is placed together with the merging traffic light 108, or the shape of the display unit 110 of the merging traffic light 108. Thus, one of the two close traffic lights whose display of signal can be recognized by the user's own vehicle more easily can be set as the attention-needing traffic light.

In the present embodiment, when the preceding vehicle ahead of the user's own vehicle accelerates, the travel control unit 84 restricts the acceleration of the user's own vehicle until the user's own vehicle passes the stop line. It is supposed that the state where the preceding vehicle has accelerated is the case where the display of the merging traffic light 108 turns green and thus the preceding vehicle has started. The merging traffic light 108 turns red quickly, and in view of this, restricting the acceleration of the user's own vehicle can prevent the user's own vehicle from braking suddenly or passing the stop line.

In the formation according to the present embodiment, if the state where the attention-needing traffic light displays the red signal continues for the predetermined time T3 or more, the travel control unit 84 repeats the gradual advance control for the user's own vehicle. In the case where the merging traffic light 108 is the vehicle-actuated traffic light, by performing the gradual advance control for the user's own vehicle, the sensor of the traffic light can detect the user's own vehicle.

1. A vehicle control device that performs travel control of a user's own vehicle at least partially automatically, the vehicle control device comprising:
a traffic light recognition unit configured to recognize a traffic light that displays a signal for traffic in a user's own vehicle lane where the user's own vehicle is traveling;
a close traffic light setting unit configured to, in a case where a plurality of recognition traffic lights that are recognized by the traffic light recognition unit exist and when a difference between a distance from the user's own vehicle to one of the recognition traffic lights and a distance from the user's own vehicle to another of the recognition traffic lights is less than a first predetermined distance or when a distance from the one recognition traffic light to the other recognition traffic light is less than a second predetermined distance, set the one recognition traffic light and the other recognition traffic light as close traffic lights;
an attention-needing traffic light setting unit configured to set at least one of a plurality of the close traffic lights as an attention-needing traffic light for the user's own vehicle, on a basis of a positional relation between the user's own vehicle and the close traffic lights; and
an assistance control unit configured to perform at least acceleration/deceleration control for the user's own vehicle in accordance with the signal displayed by the attention-needing traffic light.

2. The vehicle control device according to claim 1, wherein the attention-needing traffic light setting unit sets the positional relation between the user's own vehicle and the close traffic light in accordance with a distance between the user's own vehicle and the close traffic light, a distance between the user's own vehicle and an accompaniment that is placed together with the close traffic light, or a shape of a display unit of the close traffic light.

3. The vehicle control device according to claim 1, further comprising a plurality of traffic light detection units configured to detect the traffic light in different detection directions with respect to the user's own vehicle, wherein
the assistance control unit selects the traffic light detection unit in accordance with a distance between the user's own vehicle and the close traffic light, and performs at least the acceleration/deceleration control for the user's own vehicle in accordance with the signal displayed by the attention-needing traffic light that is detected by the selected traffic light detection unit.

4. The vehicle control device according to claim 1, further comprising an adjacent lane determination unit configured to determine that an adjacent lane that is adjacent to the user's own vehicle lane exists, upon detection of the adjacent lane or detection of an adjacent vehicle that travels adjacent to the user's own vehicle in a same direction, wherein
when the adjacent lane exists, the traffic light recognition unit distinguishes between the traffic light that displays the signal for the traffic in the user's own vehicle lane and the traffic light that displays the signal for traffic in the adjacent lane, and recognizes, as the recognition traffic light, the traffic light that displays the signal for the traffic in the user's own vehicle lane.

5. The vehicle control device according to claim 1, wherein when a preceding vehicle ahead of the user's own vehicle accelerates, the assistance control unit restricts acceleration of the user's own vehicle until the user's own vehicle passes a stop line corresponding to the recognition traffic light.

6. The vehicle control device according to claim 1, wherein when the user's own vehicle is in a stop state before a stop line corresponding to the recognition traffic light and the traffic light as the recognition traffic light keeps displaying, for a first predetermined time or more, a signal indicating that forward movement is prohibited, the assistance control unit controls the user's own vehicle to repeat traveling and stopping so that the user's own vehicle approaches the stop line corresponding to the recognition traffic light.

7. The vehicle control device according to claim 1, further comprising a merging point recognition unit configured to, in a case where a time for which the recognition traffic light displays a signal indicating that forward movement is allowed is less than a second predetermined time, recognize a position of the user's own vehicle as a merging point where a frontage road merges with a main lane, wherein:
when the position of the user's own vehicle is the merging point, the close traffic light setting unit sets the close traffic lights as merging traffic lights each displaying a signal to control traffic at the merging point; and
the attention-needing traffic light setting unit sets at least one of a plurality of the merging traffic lights as the attention-needing traffic light for the user's own vehicle.

8. The vehicle control device according to claim 1, further comprising a merging point recognition unit configured to, in a case where an oncoming vehicle does not exist and the user's own vehicle lane is curved, recognize a position of the user's own vehicle as a merging point where a frontage road merges with a main lane, wherein:
when the position of the user's own vehicle is the merging point, the close traffic light setting unit sets the close traffic lights as merging traffic lights each displaying a signal to control traffic at the merging point; and
the attention-needing traffic light setting unit sets at least one of a plurality of the merging traffic lights as the attention-needing traffic light for the user's own vehicle.

9. A vehicle control method for performing travel control of a user's own vehicle at least partially automatically, the vehicle control method comprising:
a traffic light recognizing step of recognizing a traffic light that displays a signal for traffic in a user's own vehicle lane where the user's own vehicle is traveling;
a close traffic light setting step of, in a case where a plurality of recognition traffic lights that are recognized in the traffic light recognizing step exist and when a difference between a distance from the user's own vehicle to one of the recognition traffic lights and a distance from the user's own vehicle to another of the recognition traffic lights is less than a first predetermined distance or when a distance from the one recognition traffic light to the other recognition traffic light is less than a second predetermined distance, setting the one recognition traffic light and the other recognition traffic light as close traffic lights;
an attention-needing traffic light setting step of setting at least one of a plurality of the close traffic lights as an attention-needing traffic light for the user's own vehicle on a basis of a positional relation between the user's own vehicle and the close traffic lights; and
an assistance control step of performing at least acceleration/deceleration control for the user's own vehicle in accordance with the signal displayed by the attention-needing traffic light.

10. The vehicle control method according to claim 9, wherein in the attention-needing traffic light setting step, the positional relation between the user's own vehicle and the close traffic light is set in accordance with a distance between the user's own vehicle and the close traffic light, a distance between the user's own vehicle and an accompaniment that is placed together with the close traffic light, or a shape of a display unit of the close traffic light.

11. The vehicle control method according to claim 9, wherein:
the user's own vehicle includes a plurality of traffic light detection units configured to detect the traffic light in different detection directions with respect to the user's own vehicle; and
in the assistance control step, the traffic light detection unit is selected in accordance with a distance between the user's own vehicle and the close traffic light, and at least the acceleration/deceleration control for the user's own vehicle is performed in accordance with the signal displayed by the attention-needing traffic light that is detected by the selected traffic light detection unit.

12. The vehicle control method according to claim 9, further comprising:
an adjacent lane determining step of determining that an adjacent lane that is adjacent to the user's own vehicle lane exists, upon detection of the adjacent lane or detection of an adjacent vehicle that travels adjacent to the user's own vehicle in a same direction, wherein
in the traffic light recognizing step, when the adjacent lane exists, the traffic light that displays the signal for the traffic in the user's own vehicle lane and the traffic light that displays the signal for traffic in the adjacent lane are distinguished, and the traffic light that displays the signal for the traffic in the user's own vehicle lane is recognized as the recognition traffic light.

13. The vehicle control method according to claim 9, wherein in the assistance control step, when a preceding vehicle ahead of the user's own vehicle accelerates, acceleration of the user's own vehicle is restricted until the user's own vehicle passes a stop line corresponding to the recognition traffic light.

14. The vehicle control method according to claim 9, wherein in the assistance control step, when the user's own vehicle is in a stop state before a stop line corresponding to the recognition traffic light and the traffic light as the recognition traffic light keeps displaying, for a first predetermined time or more, a signal indicating that forward movement is prohibited, the user's own vehicle is controlled to repeat traveling and stopping so that the user's own vehicle approaches the stop line corresponding to the recognition traffic light.

15. The vehicle control method according to claim 9, further comprising a merging point recognizing step of, in a case where a time for which the recognition traffic light displays a signal indicating that forward movement is allowed is less than a second predetermined time, recognizing a position of the user's own vehicle as a merging point where a frontage road merges with a main lane, wherein:
in the close traffic light setting step, when the position of the user's own vehicle is the merging point, the close traffic lights are set as merging traffic lights each displaying a signal to control traffic at the merging point; and
in the attention-needing traffic light setting step, at least one of a plurality of the merging traffic lights is set as the attention-needing traffic light for the user's own vehicle.

16. The vehicle control method according to claim 9, further comprising a merging point recognizing step of, in a case where an oncoming vehicle does not exist and the user's own vehicle lane is curved, recognizing a position of the user's own vehicle as a merging point where a frontage road merges with a main lane, wherein:
in the close traffic light setting step, when the position of the user's own vehicle is the merging point, the close traffic lights are set as merging traffic lights each displaying a signal to control traffic at the merging point; and
in the attention-needing traffic light setting step, at least one of a plurality of the merging traffic lights is set as the attention-needing traffic light for the user's own vehicle.
